(19) United States
(12) Patent Application Publication
(10) Pub. No.: US 2025/0141826 A1
(43) Pub. Date: May 1, 2025

(54) METHOD, SERVER, AND USER TERMINAL FOR PROVIDING REACTION CONTENTS

(71) Applicant: KAKAO CORP., Jeju-si (KR)

(72) Inventors: Yoon Jin CHOI, Seongnam-si (KR); Seul Gi KIM, Yongin-si (KR)

(21) Appl. No.: 18/924,180

(22) Filed: Oct. 23, 2024

(30) Foreign Application Priority Data
Oct. 30, 2023 (KR) 10-2023-0146760

(51) Int. Cl. H04L 51/52; H04L 51/10

(52) U.S. Cl. CPC H04L 51/52; H04L 51/10

(57) ABSTRACT

Proposed is a method for providing reaction contents by a server. The method may include receiving a request to post a custom content for at least one reaction content and an object related to the custom content on a first user's profile screen from a first user terminal, and in response to a request to view a first user's profile screen from a second user terminal, providing the first user's profile screen comprising the object to the second user terminal. The method may further include providing at least one reaction content for the object to the second user terminal, wherein at least one of the at least one reaction interface is based on the custom content, receiving an interaction with at least one of the at least one reaction interface from the second user terminal, and providing reaction information associated with the interaction to the first user terminal.

### CROSS-REFERENCE TO RELATED APPLICATION

This application claims priority to Korean Patent Application No. 10-2023-0146760 filed on Oct. 30, 2023, the entirety of which is incorporated herein by reference for all purposes.

### BACKGROUND

### Technical Field

The present disclosure relates to providing reaction contents.

### Description of Related Technology

With the recent proliferation of smart devices and advancements in wireless internet technology, features for sharing user profiles on social media and messaging services have become widely available. Recent media and messaging services not only allow a user to share basic personal information, such as the user's name and contact details, but also enable sharing various additional details that reflect the user's experiences, preferences, and tastes.

### SUMMARY

The present disclosure aims to post an object through an object creator's profile screen and provide a reaction interface for the object to a user accessing the object creator's profile screen.

The present disclosure also aims to provide a reaction interface for an object and a gifting interface so that a user who has viewed the object can provide a gift along with a reaction to the poster of the object.

In one aspect, there is provided a method for providing reaction contents by a server, the method including: receiving a request to post a custom content for at least one reaction content and an object related to the custom content on a first user's profile screen from a first user terminal; in response to a request to view a first user's profile screen from a second user terminal, providing the first user's profile screen comprising the object to the second user terminal; providing information about the custom content to be displayed as part of at least one reaction interface for the object to the second user terminal; receiving an interaction with at least one of the at least one reaction interface from the second user terminal; and providing reaction information associated with the interaction to the first user terminal.

The at least one reaction interface may include a custom interface based on the custom content and a default interface unrelated to the custom content.

The at least one reaction interface may include a reaction content interface related to a reaction content and a feature interface connected to a specific feature.

The specific feature may include at least one of the following: a feature of providing a gift to the first user and a feature of sending a message to the first user.

The method may further include, in response to receiving an interaction with the feature interface from the second user terminal, providing a feature window for performing the specific feature to the second user terminal. The feature window may include information related to the object.

The information related to the object may include at least one of the following: information about details received in relation to the object from the first user terminal and characteristic information related to the first user.

The method may further include, in response to receiving an interaction with the feature interface from the second user terminal, providing a feature window for performing the specific feature to the second user terminal. The feature window may be displayed overlapping at least a part of the first user's profile screen.

The reaction information may include at least one of the following: information about a reaction content associated with the interaction, information about a specific feature associated with the interaction, and profile information for the second user.

The specific feature may be a feature of providing a gift to the first user, and the reaction information may include a viewing interface that allows viewing information about a gift provided by the first user in relation to the object.

The specific feature may be a feature of providing a gift to the first user, and the method may further include, in response to the object being provided in plural, providing information on at least one of gifts received by the first user to the first user terminal, separately by object.

The reaction interface may be displayed overlapping at least a part of the first user's profile screen.

Providing the information about the custom content may be performed in response to an interaction from the second user terminal with the object.

The object may include a details area, including details received from the first user terminal in relation to the object, and a reaction area related to a reaction to the object, and at least one of the at least one reaction interface may be provided within the reaction area.

Receiving the request may include receiving information designating one of the at least one reaction content as a designated reaction content from the first user terminal, and the object may be displayed, including the designated reaction content.

Receiving the request may include providing candidate reaction contents selectable as the custom content to the first user terminal, and the candidate reaction contents may be related to the first user's history information regarding the at least one reaction content.

The at least one reaction content may include an emoticon, and the history information may be associated with at least one of the following: the first user's recent usage history, favorite designation history, purchase history, download history, and retention history regarding emoticons.

Receiving the request may include providing candidate reaction contents selectable as the custom content to the first user terminal, and the candidate reaction contents may include a reaction content related to a characteristic of the object.

The characteristic of the object may include at least one of the following: a posting time of the object and details received from the first user terminal in relation to the object.

In another aspect, there is provided a server providing reaction contents, the server including: a memory storing instructions, and a processor configured to execute the instructions to: receive a request to post a custom content for at least one reaction content and an object related to the custom content on a first user's profile screen from a first user terminal; in response to a request to view the first user's profile screen from a second user terminal, provide the first user's profile screen comprising the object to the second user terminal; providing information about the custom content to be displayed as part of at least one reaction interface for the object to the second user terminal; receive an interaction with at least one of the at least one reaction interface from the second user terminal; and provide reaction information associated with the interaction to the first user terminal.

In yet another aspect, there is provided a method for displaying reaction information by a user terminal, the method including: transmitting to a server a request to post a custom content for at least one reaction content and an object related to the custom content on a user's profile screen, wherein the custom content is obtained based on the user's selection of the at least one reaction content; displaying the object through the user's profile screen; and displaying another user's reaction information regarding the object through the user's profile screen, wherein the reaction information is generated by the another user's interaction with a reaction interface related to the object.

In yet another aspect, there is provided a method for displaying a reaction interface by a user terminal, the method including: displaying another user's profile screen comprising an object related to a custom content, wherein the custom content is obtained based on the another user's selection of at least one reaction content; displaying at least one reaction interface for the object, wherein at least one of the at least one reaction interface is based on the custom content; and receiving an interaction with at least one of the at least one reaction interface from the another user.

The at least one reaction interface may include a reaction content interface related to a reaction content and a gifting interface connected to a feature of providing a gift to the another user, and the method may further include, in response to the user's interaction with the gifting interface, displaying a gifting feature window to overlap at least a part of the another user's profile screen.

### BRIEF DESCRIPTION OF THE DRAWINGS

FIG. 1 is a diagram illustrating an example of a network environment according to an embodiment of the present disclosure.

FIG. 2 is a flowchart for explaining a method in which a server provides information about a custom content to a second user terminal and receives reaction information from the second user terminal according to the present disclosure.

FIGS. 3 to 8 illustrate example screens in a process of performing a method for displaying a reaction interface and displaying reaction information by a first user terminal or a second user terminal according to embodiments of the present disclosure.

FIG. 9 illustrates a screen where a first user terminal displays candidate reaction contents related to content included in an object according to an embodiment of the present disclosure.

FIG. 10 illustrates a screen where a first user terminal displays candidate reaction contents related to the posting time of an object according to an embodiment of the present disclosure.

FIG. 11 is a flowchart for explaining a method for displaying reaction information by a first user terminal of the present disclosure.

FIG. 12 is a flowchart for explaining a method for displaying a custom content and a selected reaction content by a second user terminal of the present disclosure.

### DETAILED DESCRIPTION

As social networking through chat rooms has become increasingly emphasized, some chat services now offer a reaction feature for messages within these chat rooms. The reaction feature is a function that allows a user, who has viewed a message in a chat room, to select a reaction reflecting the user's emotion, response, or evaluation and leave a reaction to the message.

Recently, various methods have been developed to enable a user to easily leave a reaction reflecting the user's emotion, response, and evaluation, not only in a chat room but also in the user's profile and other areas.

Description will now be given in detail according to exemplary embodiments disclosed herein, with reference to the accompanying drawings. For the sake of brief description with reference to the drawings, the same or equivalent components may be provided with the same or similar reference numbers, and description thereof will not be repeated. In addition, in the following description of the embodiments, a detailed description of known functions and configurations incorporated herein will be omitted when it may impede the understanding of the embodiments.

While terms including ordinal numbers, such as “first” and “second,” etc., may be used to describe various components, such components are not limited by the above terms. The above terms are used only to distinguish one component from another.

As used herein, the singular forms “a”, “an,” and “the” are intended to include the plural forms as well, unless the context clearly indicates otherwise.

Each of the steps described above may be performed irrespective of the listed order, except when performed in the listed order due to a special causal relationship.

It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Hereinafter, the present disclosure will be described with reference to the attached drawings.

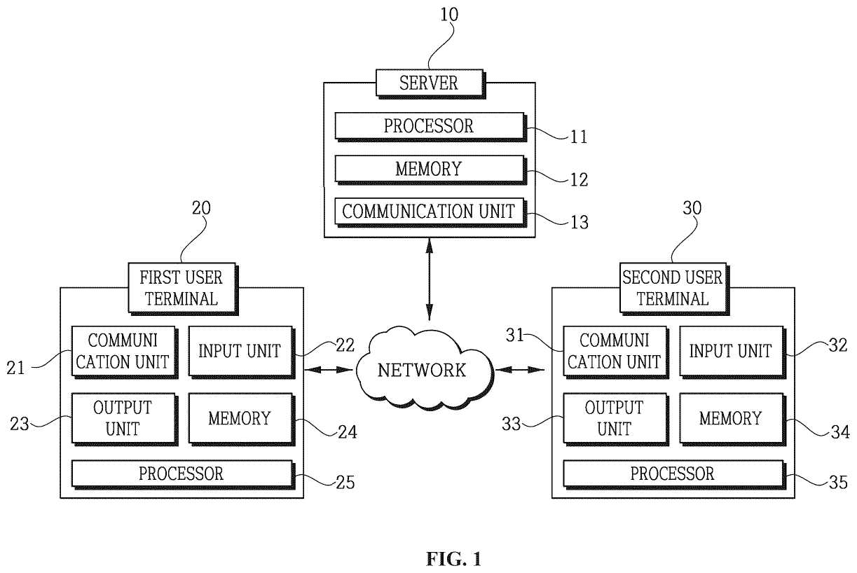

FIG. 1 is a diagram illustrating an example of a network environment according to an embodiment of the present disclosure.

A network environment according to an embodiment of the present disclosure shown in FIG. 1 may include a server 10 and user terminals 20 and 30. The user terminals 20 and 30 may include at least one user terminal 20 or 30 connected to the server 10 over a network. FIG. 1 illustrates a first user terminal 20 and a second user terminal 30 as examples of the user terminals 20 and 30.

The first user terminal 20 refers to a terminal that a first user logs into with the first user's account registered on the server 10, and the second user terminal 30 refers to a terminal that a second user logs into with the second user's account registered on the server 10.

Hereinafter, for convenience of explanation, the first user terminal 20 will be described as a user terminal that provides an object and a reaction interface, and the second user terminal 30 will be described as a user terminal that reacts to the object through the reaction interface provided by the first user terminal 20. However, the present disclosure is not limited to or specified by the functions or features that may be performed depending on a user terminal.

Communication schemes for a network is not limited. The communication schemes may include not only a communication scheme to utilize a telecommunication network (for example, a mobile communication network, wired Internet, wireless Internet, and a broadcast network), but also a short-range radio communication scheme.

In the present disclosure, the server 10 may be a device capable of transmitting and receiving information through communication with a user terminal over a network. The server 10 may be implemented as a computer device or a plurality of computer devices that provide commands, codes, files, content, services, etc.

The server 10 may include a processor 11, a memory 12, and a communication unit 13.

The processor 11 controls the overall operation of the memory 12 and the communication unit 13 to provide a reaction service to the user terminal and stores content. The reaction service refers to a feature of displaying a reaction interface for an object and receiving reaction information.

The memory 12 functions as a storage medium and may store a number of application programs running on the server 10, as well as data and commands for operation of the server 10. In one embodiment, an application that provides a social media service or messenger service that enables sharing a user's profile may be stored in the memory 12.

The memory 12 may be provided in the form of any of various hardware storage devices such as an ROM, an RAM, a flash drive, a hard drive, etc. or may be provided in the form of web storage.

The communication unit 13 may communicate with a user terminal in a wired/wireless manner over a network.

The server 10 of the present disclosure may provide a profile page to a user terminal, post an object on the profile page, and offer a reaction feature for the object.

Users who receive features or services from the server 10 of the present disclosure may be connected through a relationship called friendship. The friendship may be formed through friend requests and acceptance between the users, or by satisfying a condition such as at least one user storing the other's phone number. In some cases, a feature of receiving a reaction to an object may be available between users who are not friends.

The server 10 may receive a request from the first user terminal 20 to post a custom content for a reaction content and an object related to the custom content on the first user's profile screen. In response to a request from the second user terminal 30 to view the first user's profile screen, the server 10 may provide the first user's profile screen with the object to the second user terminal 30 and provide information about the custom content to be displayed as part of at least one reaction interface for the object to the second user terminal 30. The server 10 may receive an interaction with at least one reaction interface from the second user terminal 30 and provide reaction information associated with the interaction to the first user terminal 20.

Here, an object refers to a visual object that visually displays information including specific details designated by the first user. The object may be a sticker image, an emoticon, an icon, a content post, etc. The first user terminal 20 may transmit information on the creation of an object to the server 10 to request the creation of the object. The information on the creation of the object may include the details information designated by the first user, display option information (e.g., size, position, and shape) of the object, and a custom content. The object may include a details area, including details received in relation to the object, and a reaction area related to a reaction to the object.

The object may be posted on the first user's profile screen. Here, a profile screen refers to an interface that displays a user's personal information or status information in a social media or messenger service provided by the server 10. The profile screen may include the user's name, profile picture, status message, contact information, profile background photo, etc.

An object may be provided to the first user terminal 20 or the second user terminal 30 through the first user's profile screen. When the first user terminal 20 or the second user terminal 30 requests to view the first user's profile screen from the server 10, the object may be provided on the first user's profile screen.

Here, a custom content refers to at least one content selected by the first user from among reaction contents. The first user may select at least one of at least one candidate reaction content provided from the server as a custom content.

In this case, a reaction content refers to graphic information that expresses a user's emotions, facial expressions, etc. The reaction content may be various types of graphic or multimedia information. For example, the reaction content may include an emoticon, a static image, a dynamic image, sound information, etc.

In this case, a reaction interface refers to an interface provided to the second user terminal 30 to offer a reaction feature for an object. The reaction interface may include at least one individual interface. The second user may select at least one individual interface from among reaction interfaces to leave a reaction to an object.

Here, the reaction information refers to information related to the second user's reaction to the object provided on the first user terminal 20. The reaction information may be displayed in response to a reaction information viewing request from the first user terminal 20. The reaction information may include at least one of the following: information about a reaction content corresponding to an interaction, profile information about the second user, information related to a specific feature, and a detailed information viewing interface related to the specific feature.

The user terminals 20 and 30 include a first user terminal 20 providing an object and a reaction interface, and a second user terminal 30 reacting to the object through the reaction interface.

The user terminals 20 and 30 may include communication units 21 and 31, input units 22 and 32, output units 23 and 33, memories 24 and 34, and processors 25 and 35.

The communication units 21 and 31 may communicate with the server 10 or other terminals in a wired or wireless manner.

The input units 22 and 32 may receive various information through a user's operation and input. The input units 22 and 32 may be touch screen modules, keyboards, mouses, buttons, cameras, styluses, microphones, etc.

The user terminals 20 and 30 may receive a user interaction through the input units 22 and 32. The interaction refers to the action of the user's operating an input unit to enter information reflecting the user's selection or intention into a user terminal. For example, the interaction may include touching on a touchscreen, clicking with a mouse, typing on a keyboard, providing voice input through a microphone, capturing an image using a camera, recognizing movements through a motion sensor, and the like.

The output units 23 and 33 may output various information. The output units 23 and 33 may be display devices, speakers, vibration generators, tactile generators, etc. In some cases, the output units 23 and 33 may be devices (e.g., Bluetooth earphone) respectively connected to the user terminals 20 and 30 through wired or wireless communication (e.g., short-range radio communication such as Bluetooth) to receive and output signals.

Each of the memories 24 and 34 functions as a storage medium and may store a plurality of application programs running on a corresponding one of the user terminal 20 and 30, as well as and data and instructions for operating the corresponding one of the user terminal 20 and 30. Each of the memories 24 and 34 may be provided in the form of any of various hardware storage devices such as an ROM, an RAM, a flash drive, a hard drive, etc. or may be provided in the form of web storage.

In one embodiment, each of the memories 24 and 34 may store an application for providing a social media service or messenger service that enable sharing the user's profile.

The processors 25 and 35 control the overall operation of the communication units 21 and 31, input units 22 and 32, output units 23 and 33, and memories 24 and 34 to execute an application related to a social media service or messenger service.

The first user terminal 20 may transmit to the server 10 a request to post a custom content for at least one reaction content and an object related to the custom content on the user's profile screen. Here, the custom content may be obtained based on the user's selection of at least one reaction content. The first user terminal 20 may display the object through the user's profile screen and display information about another user's reaction to the object through the user's profile screen. Here, reaction information may be generated based on another user's interaction with a reaction interface related to the object.

The second user terminal 30 may display another user's profile screen including an object related to a custom content. Here, the custom content may be obtained based on another user's selection of at least one reaction content. The second user terminal 30 may display at least one reaction interface for the object. Here, at least one of the at least one reaction interface may be based on the custom content(s). The second user terminal 30 may receive an interaction for at least one of the at least one reaction interface from the second user.

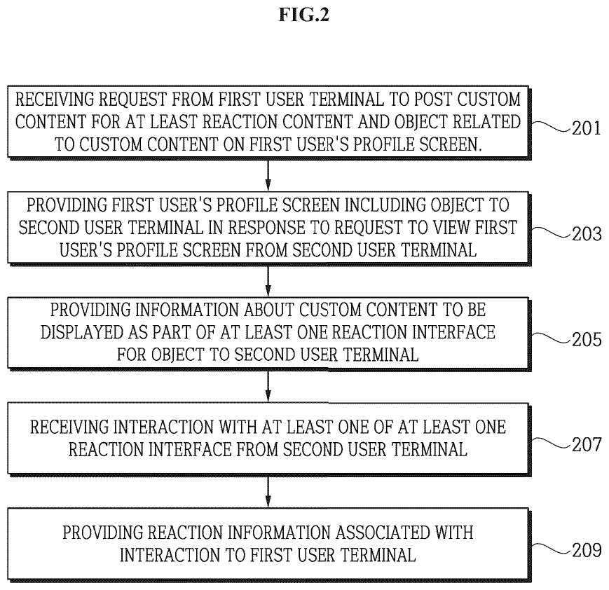

Hereinafter, an embodiment of a method for providing reaction contents by the server 10 of the present disclosure will be described with reference to FIG. 2. The present disclosure relates to a method for providing an object and a reaction feature through a profile screen provided in a social media service, social network service (SNS), or messenger service by a server.

FIG. 2 is a flowchart for explaining a method for displaying a reaction interface and receiving reaction information through a profile screen by the server 10 of the present disclosure. First, a method of providing reaction contents, as carried out between the server 10, the first user terminal 20, and the second user terminal 30, will be described with reference to FIG. 2.

In operation 201, the server 10 receives a request from the first user terminal 20 to post a custom content and an object related to the custom content on the first user's profile screen.

The server 10 may provide the first user terminal 20 with a feature of creating an object. For example, the first user terminal 20 may request the server 10 to create and post an object through a feature of editing or modifying the first user's profile screen. Specifically, the server 10 may provide the first user terminal 20 with a feature of creating and posting various objects (e.g., a profile photo, a status message, a sticker, etc.) on the first user's profile screen. The first user terminal 20 may select one of the various objects and request to create and post the selected object.

The object may include a details area, including details received in relation to the object, and a reaction area related to a reaction to the object. The first user may input specific details in the details area to create the object on the server 10. Accordingly, the object may be used to induce the second user's reaction to the specific details input by the first user.

Additionally, the first user may provide a custom content while requesting the server 10 to create an object. The server 10 may provide the first user terminal 20 with candidate reaction contents for a custom content. The first user may provide the custom content to the server 10 by selecting at least one of the candidate reaction contents.

In some cases, the number of candidate reaction contents selectable as a custom content may be predetermined or limited. The number of candidate reaction contents selectable as a custom content may be determined based on a size of the object.

Here, the candidate reaction contents may be determined in various ways. For example, the candidate reaction contents may include at least one predetermined reaction content. In this case, the candidate reaction contents may be provided equally to a plurality of users who are to input a custom content.

In another example, different candidate reaction contents may be determined depending on a characteristic of a user entering a custom content. Accordingly, the candidate reaction contents may be determined differently depending on the first user's history information regarding reaction contents. For example, the reaction contents are emoticons, the candidate reaction contents provided to the first user terminal may include emoticons related to the first user's emoticon usage history, favorite emoticon designation history, emoticon purchase history, emoticon download history, or emoticon retention history.

In another example, the candidate reaction contents may be determined based on a characteristic of an object. The characteristic of the object may include at least one of a posting time of the object and details received from the first user terminal in relation to the object. For example, if the posting time of the object is near the beginning of the year, the candidate reaction contents may include emoticons related to New Year's greetings. Additionally, when the first user terminal inputs graduation-related details in relation to the object, the candidate reaction contents may include emoticons related to graduation.

In some cases, the custom content may be acquired not by selecting a reaction content but by selecting a content including a specific feature. For example, when the first user selects a content including a gifting feature as a custom content, the reaction interface may include a gifting feature interface.

The first user may set how to display a reaction interface in subsequent operation 203 while making a request to the server 10 to create an object. For example, the first user may determine whether the reaction interface is displayed in response to the second user's interaction with the object or whether the reaction interface is displayed within the object.

In some cases, how the reaction interface is displayed may be determined based on a size of the object. For example, when the size of the object is small, the reaction interface may be displayed separately from the object in response to the second user's interaction with the object. However, if the size of the object is large, the reaction interface may be displayed within the object. In this case, the second user may be provided with a reaction interface and interact therewith without having to interact with a separate object.

In the above example, when the reaction interface is not displayed within the object, at least one of the reaction contents may be designated as a designated reaction content and displayed within the object. The first user terminal 20 may designate any one of the reaction contents selected based on the custom content as the designated reaction content. The designated reaction content may be displayed within the object when the object is displayed in subsequent operation 203.

The server 10 may provide a setting interface for specifying the size and position of the object to be displayed on the first user terminal 20. The first user terminal 20 may display the object on the first user's profile screen and provide a setting interface related to a feature that allows the first user to change the size, position, and shape of the object.

In operation 203, the server 10 provides the first user's profile screen including the object to the second user terminal 30 in response to a request to view the first user's profile screen from the second user terminal 30.

The second user may request to view the first user's profile screen from the server 10 in various ways. For example, the second user may select the first user's profile picture from a friend list or chat room and request to view the first user's profile screen from the server 10.

The server 10 may provide the second user terminal 30 with the first user's profile screen including an object that includes a custom content. Specifically, the object may be determined according to display options (size, position, color, visual effect, etc.) set by the first user on the first user's profile screen.

The object displayed in operation 203 may be divided into two or more areas. Specifically, the object may include a details area, including details received in relation to the object, and a reaction area related to a reaction to the object.

In operation 205, the server 10 provides information about the custom content to be displayed as part of at least one reaction interface for the object to the second user terminal 30.

When the server 10 receives an interaction regarding the object from the second user terminal 30, the server 10 may provide the information about the custom content to be displayed as part of at least one reaction interface for the object to the second user terminal 30. In this case, the second user terminal 30 may display the reaction interface including the custom content.

Specifically, when the server 10 receives an interaction regarding the object from the second user terminal 30, the server 10 may provide the first user's profile screen including a reaction interface to the second user terminal 30. The server 10 may provide the profile screen with the reaction interface in response to receiving an interaction with the reaction area within the object.

The second user terminal 30 may display the reaction interface in various ways. The second user terminal 30 may display the reaction interface overlapping at least a part of the first user's profile screen. For example, the second user terminal 30 may display the reaction interface around an object. In another example, the second user terminal 30 may display the first user's profile screen opaquely and the reaction interface in front of the first user's profile screen.

In some cases, the server 10 may provide information about at least one custom content for the object to the second user terminal 30 even if no interaction regarding the object has been received from the second user terminal 30. For example, although no interaction regarding the object has been received from the second user, the second user terminal 30 may display a reaction interface may be displayed including custom content within the object. Here, the reaction interface may be displayed in the reaction area of the object. In this case, the second user may interact with the reaction interface displayed within the object.

The reaction interface may include a reaction content interface related to a reaction content and a feature interface connected to a specific feature. Here, the specific feature may be a feature that the second user can perform for the first user in relation to the object. For example, the specific feature may be a feature that allows the second user to provide a gift, message, card, etc., to the first user.

The reaction interface may include a custom interface and a default interface. Here, the custom interface is an interface that is based on a custom content. Specifically, the custom interface refers to an interface in which a reaction content selected by the first user based on the custom content is displayed.

Here, the default interface refers to an interface included in the reaction interface, regardless of the first user's selection. The default interface may be determined according to the server's policy. For example, when the server sets a gifting feature interface as the default interface, the reaction interface may be provided with the gifting feature interface regardless of the first user's selection.

The relationship between the custom interface and the default interface is conceptually different from the relationship between the reaction content interface and the feature interface described above. Specifically, any reaction content interface or feature interface may be a custom interface based on the first user's selection, or may be a default interface based on the server's policy.

For example, the default interface may correspond to at least one of the reaction content interface. For example, if there are three reaction content interfaces, only one of the reaction content interfaces may correspond to the default interface.

In another example, the default interface may correspond to a feature interface. Specifically, at least one of a gifting interface and a messaging interface may correspond to the default interface.

The second user terminal 30 may display the feature interface along with the reaction content interface. Specifically, the second user terminal 30 may display the reaction content interface and the feature interface in response to an interaction regarding the object from the second user.

In some cases, the server 10 may provide information about a reaction content together with the object in response to a request to view the first user's profile screen from the second user terminal 30 even when there is no interaction with the object. Specifically, the object may include a details area, including details received from the first user terminal 20 in relation to the object, and a reaction area related to a reaction to the object. The first user terminal 20 may display the reaction interface within the reaction area even when there is no interaction regarding the object by the first user.

In operation 207, the server 10 receives an interaction with at least one of the at least one reaction interface from the second user terminal 30.

The server 10 may receive reaction information from the second user terminal 30 based on the interaction with the reaction interface.

The server 10 may receive the interaction with the reaction content interface from the second user terminal 30. If the reaction content interface is a single button through which a second user can input an interaction, there may be a single type of reaction. However, when the reaction content interface is provided as a choice-based reaction content interface where the second user can select one of the options and input an interaction, there may be multiple types of reaction based on the second user's selection.

The server 10 may receive an interaction with a feature interface from the second user terminal 30. Here, the feature interface refers to an interface provided to the second user terminal 30 to display a feature window related to the object. When the server 10 receives an interaction with the feature interface, the server 10 may provide the second user terminal 30 with a feature window for performing a specific feature. Here, the feature window refers to a separate page that performs the specific feature related to the object.

The second user terminal 30 may display the feature window in various ways. For example, the second user terminal 30 may display the feature window on the first user's profile screen. Specifically, the feature window may be displayed, covering a part of the first user's profile screen. In another example, when the second user terminal 30 displays the first user's profile screen on a part of the screen, the second user terminal 30 may display a new window on another part of the screen and show the feature window through the new window.

The feature window may include information related to the object. Specifically, the feature window may include at least one of the following: information about specific details included in the object, information about the first user who posted the object, and information related to the specific feature.

For example, the specific feature may correspond to a gifting feature. In this case, the feature window may correspond to a gift box. In this case, the gift box may include information about at least one of the first user's name, profile, and user ID. For example, the gift box may include information about the first user, such as “Gift recommendations for Peter.”

Additionally, the gift box may include gift recommendation information as information related to the specific feature (gifting feature). Specifically, the second user terminal 30 may request gifting for a poster of an object that includes details such as “Start diet!” In this case, the gift recommendation information may recommend a gift related to “diet.”

Immediately after receiving an interaction regarding at least one reaction interface from the second user, the second user terminal 30 may temporarily display a reaction content corresponding to the interaction.

In operation 209, the server 10 provides reaction information associated with the interaction to the first user terminal 20.

The first user terminal 30 may display the reaction information in various ways. For example, the first user terminal 30 may display reaction information overlapping at least a part of the first user's profile screen. Specifically, the reaction information may be displayed in the form of a window (modal view) that covers at least a part of the first user's profile screen.

In another example, the first user terminal 30 may display reaction information in the form of a separate page.

The server 10 may provide reaction information corresponding to the interaction to the first user terminal 20. The reaction information may include at least one of the following: information about a reaction content associated with the interaction, information about a specific feature associated with the interaction, and profile information about the second user.

The information about the reaction content associated with the interaction may be based on details of the reaction content, which is input by the second user. Specifically, the second user may input a reaction related to “cheering” through the reaction content interface. In this case, information about a reaction content corresponding to an interaction may include at least one of an image, an emoticon, and a text message related to the details of “cheering.”

The information about the specific feature associated with the interaction may include information provided by the specific feature and a detailed information viewing interface. Here, the detailed information viewing interface refers to an interface related to viewing detailed information provided by the specific feature. For example, the specific feature may correspond to a feature of providing a gift to the first user. In this case, the information about the feature of providing a gift (i.e., information about a specific feature) may correspond to gift information (i.e., information provided by a specific feature) and a gift box viewing interface (i.e., a detailed information viewing interface).

The second user's profile information may be displayed in various ways. Specifically, the first user terminal may display the profile information of the second user who sent the most recent reaction, with higher priority (at the top). For example, if Jane sent a reaction on Sep. 17, 2023 and Jack sent a reaction on Sep. 16, 2023, Jane may be displayed higher than Jack.

Additionally, the first user terminal 20 may display information related to a specific feature in reaction information. For example, a specific feature may correspond to a gifting feature. In this case, the first user terminal 20 may display the profile information of the second user, who most recently sent a reaction, with highest priority (at the top). For example, if Mike sent a gift to the first user through a gifting interface on Sep. 13, 2023, Mike may be displayed higher than Jane even if Jane sent a reaction on Sep. 17, 2023.

The first user terminal 20 may display a detailed information viewing interface related to a specific feature in reaction information. The first user terminal 20 may display specific details including information related to an object, in response to an interaction with the detailed information viewing interface.

When there is a plurality of objects, the first user terminal 20 may display information about at least a part of the specific details, separately by object. For example, when the first user terminal 20 receives gifts related to a plurality of objects, the gifts (specific details) related to the plurality of objects may be displayed separately by object. For example, the first user terminal 20 may distinguish the plurality of objects through a tab area. Specifically, the first user terminal 20 may post an object such as “Start a diet!” and receive a gift related to the object. In this case, the first user terminal 20 may display a tab corresponding to “Start a diet!” in the tab area. Additionally, the first user terminal 20 may display a gift related to the object in the tab corresponding to “Start a diet!”

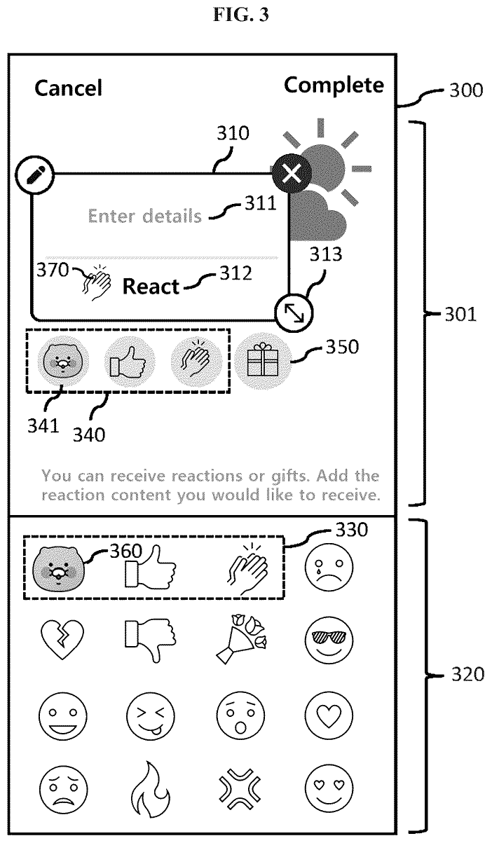

Hereinafter, with reference to FIGS. 3 to 10, examples of a method for providing a reaction interface and reaction information through a profile screen by the server 10 described with reference to FIG. 2 will be described.

FIGS. 3 to 10 illustrate screens in a process of displaying a reaction interface and reaction information by the first user terminal 20 or the second user terminal 30 according to embodiments of the present disclosure.

FIG. 3 illustrates a screen 300 showing a state in which the first user terminal 20 transmits a request for the creation of an object and a custom content 330 to the server 10 in order for the server 10 to perform operation 201 of FIG. 2.

Referring to FIG. 3, the first user terminal 20 may display an interface through which the first user may input information on the creation of an object 310 through a first user's profile screen 300. Specifically, the object 310 may include a details area 311, including details received in relation to the object 310, and a reaction area 312 related to reactions to the object 310.

Additionally, the first user may set the size of the object 310 through a size setting interface 313. Additionally, the first user may also change a position where the object 310 will be posted, by touching or clicking and then dragging the object 310. The first user terminal 20 may allow the object 310 to move only within an editable area 301 through this position change feature. Additionally, although not shown in the drawing, the first user may also set the transparency or color of the object 310.

The first user terminal 20 may transmit the custom content 330 to the server 10. Specifically, when the server 10 receives a request for the creation of the object 310 from the first user terminal 20, the server 10 may provide candidate reaction contents 320 for the custom content 330 to the first user terminal 20. The first user may select at least one of the candidate reaction contents 320 and transmit the at least one selected candidate reaction content to the server 10 as a custom content 330.

The first user terminal 20 may include information 360 related to the first user's history information in the custom content 330. The history information may include at least one of the first user's recent usage history, favorite designation history, purchase history, download history, and possession history regarding emoticons. For example, the custom content 330 may be an emoticon purchased by the first user.

In some cases, the information 360 related to the first user's history information may correspond to at least one custom content 330. For example, if the number of custom contents 330 is three, there may be only one information 360 related to the first user's history information.

Before requesting to post the object 310, the first user terminal 20 may display a screen in advance on which a gifting interface 350 will be displayed, along with a reaction content interface 340. Specifically, the first user terminal 20 may display a reaction content interface 340 based on a reaction content and a gifting (feature) interface 350, not based on a custom content.

The first user terminal 20 may transmit information about a designated reaction content 370 to the server 10. Specifically, the first user may transmit a request to select one of the candidate reaction contents 320 as the designated reaction content 370. Although not shown in the drawing, in some cases, the server 10 may determine and provide a content 341, which is displayed with the highest priority among the custom contents 330, as the designated reaction content 370.

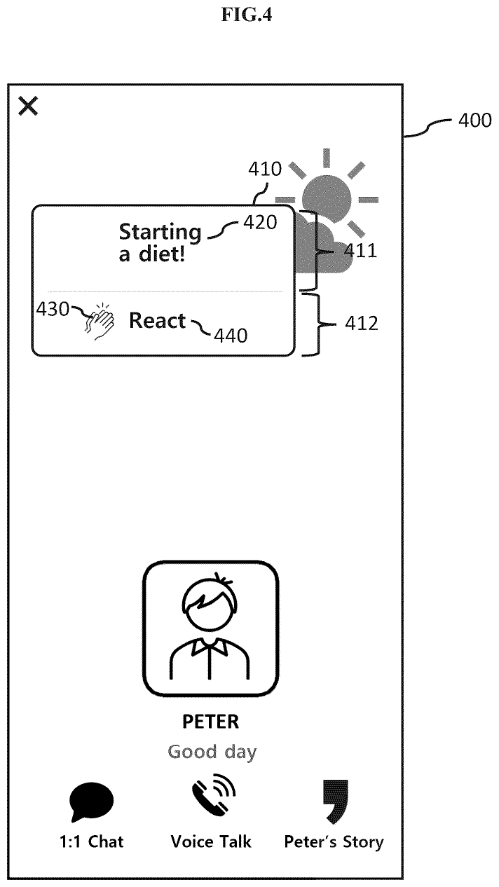

FIG. 4 illustrates a screen 400 where the second user terminal 30 displays the first user's profile screen including an object 410 in order for the server 10 to perform operation 203 of FIG. 2.

Referring to FIG. 4, the object 410 may include a details area 411 and a reaction area 412. The details area 411 may include details 420 received from the first user terminal 20 in relation to the object. For example, the details area 411 may include details such as “Starting a diet” 420 received from the first user terminal 20.

In some cases, the reaction area 412 may include a designated reaction content 430 and a reaction display interface 440. The designated reaction content 430 may correspond to any one content selected by the first user from among candidate reaction contents. For example, the first user may have selected a clapping reaction as the designated reaction content 430 among the candidate reaction contents 320 in FIG. 3. In this case, the first user terminal 20 may display the clapping reaction 430 as the designated reaction content 430 in the reaction area 412 of the object 410.

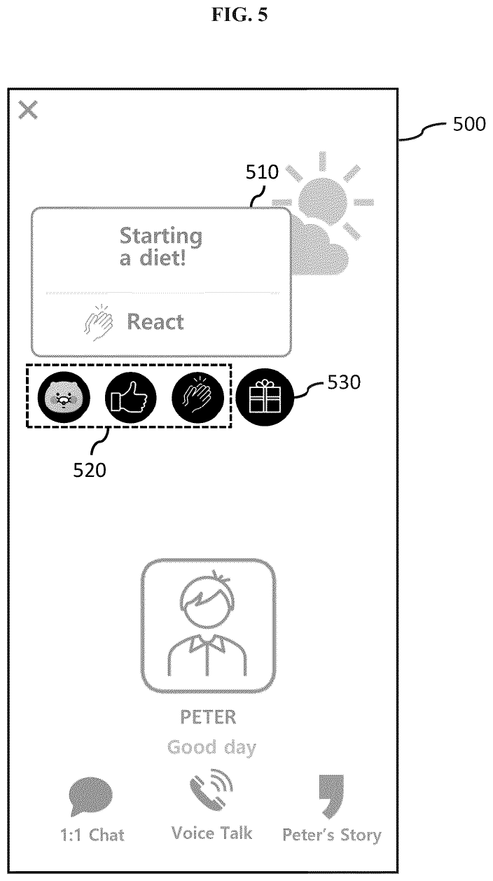

FIG. 5 shows the second user terminal 30 displaying a reaction content interface 520 and a gifting interface 530 in order for the server 10 to perform operation 205 of FIG. 2.

FIG. 5 may be displayed when an interaction with the object 410 or the reaction display interface 440 in FIG. 4 is obtained.

Referring to FIG. 5, the second user terminal 30 displays the reaction interfaces 520 and 530 in response to an interaction with the object 510 or the reaction display interface. The reaction interfaces 520 and 530 may include the reaction content interface 520 and a gifting interface (feature interface) 530, which includes a gifting feature (specific feature).

The second user terminal 30 may display the reaction interface overlapping at least a part of the first user's profile screen. Specifically, the second user terminal 30 may display the reaction content interfaces 520 and 530 around the object 510. For example, the second user terminal 30 may display the reaction content interfaces 520 and 530 below the object 510.

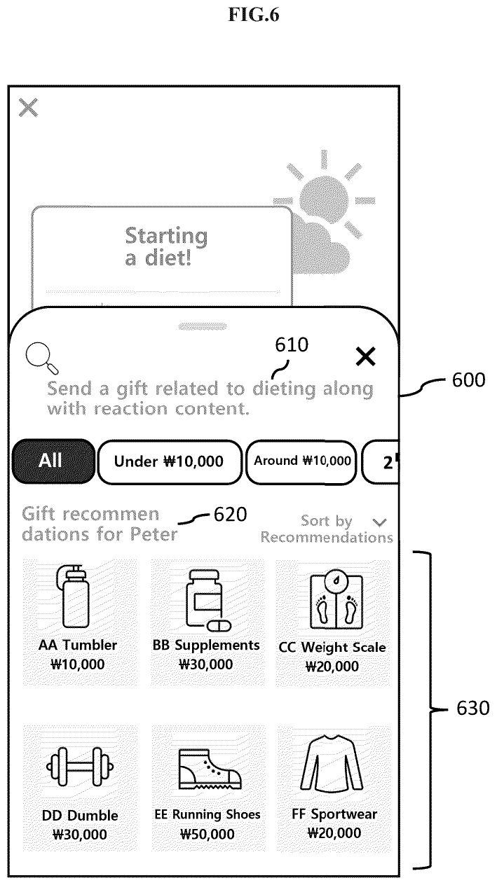

The second user terminal 30 may obtain an interaction with at least one of the reaction interfaces 520 and 530 from the second user. When the second user terminal 30 obtains an interaction with the gifting interface 530, the screen in FIG. 6 may be displayed.

FIG. 6 shows the second user terminal 30 displaying a gifting feature window 600 on the first user's profile screen of the second user terminal 30.

In FIGS. 6 to 8, the specific feature will be described as a feature of providing a gift to the first user.

The second user terminal 30 may display a gifting feature window 600 in response to an interaction with a gifting interface. The second user terminal 30 may display the gifting feature window 600 in various ways. For example, the second user terminal 30 may display the gifting feature window 600 on the first user's profile screen. Specifically, the second user terminal 30 may display the gifting feature window 600 overlapping with at least a part of the first user's profile screen.

The gifting feature window 600 may include information related to an object. Specifically, the gifting feature window 600 may include information 610 and 630 about details received from the first user terminal in relation to the object, and characteristic information 620 related to the first user. Here, the information about the details received in relation to the object may include information 610 related to specific details and gift recommendation information 630 related to the object.

The second user terminal 30 may display the information 610 related to the specific details included in the object in the gifting feature window 600. For example, the second user terminal 30 may display information such as “Send a gift related to dieting along with reaction content” 610 related to the detail of the object (e.g., “Starting a diet!”) input by the first user.

The information 620 about the first user who posted the object may include information about at least one of the first user's name, profile, and user ID. For example, the second user terminal 30 may include information about the first user, such as “Gift recommendations for Peter” 620, in the gifting feature window 600.

Gift recommendation information 630 related to the object may be displayed when the second user terminal 30 displays a feature window. For example, the second user terminal 30 may request gifting for an object poster, who posted an object that includes details such as “Starting a diet!” In such a case, the second user terminal 30 may display gift recommendation information 630 related to “dieting.”

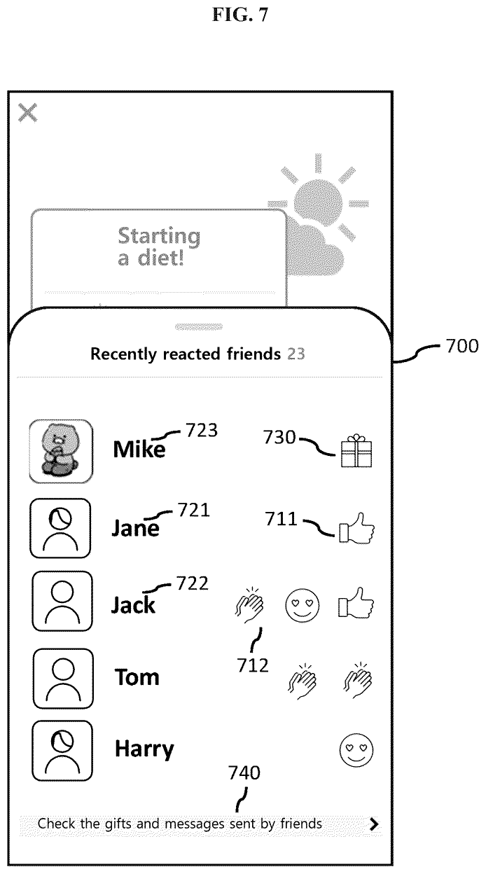

FIG. 7 illustrates a screen where the server 10 provides reaction information 700 related to an interaction to the first user terminal 20 in order to perform operation 209 of FIG. 2.

FIG. 7 may be provided to the first user terminal 20 in response to an interaction with the reaction interface in FIG. 5.

Referring to FIG. 7, reaction information 700 may include information 711 and 712 about reaction contents associated with interactions, information 730 and 740 about specific features associated with interactions, and profile information 721, 722, and 723 about the second user. In this case, the information about the specific features associated with the interactions may include information 730 about a user who provided a gift (specific function) and a gift box viewing interface 740.

The first user terminal 20 may display the reaction information 700 through the first user's profile screen. For example, the first user terminal 30 may display the reaction information 700 overlapping at least a part of the first user's profile screen. Specifically, the reaction information may be displayed in the form of a window (modal view) that covers at least a part of the first user's profile screen.

The first user terminal 20 may display the user 721, who most recently sent a reaction among the users 721, 722, 723, with highest priority (at the top). For example, if Jane 721 sent a reaction on Sep. 17, 2023, and Jack 722 sent a reaction on Sep. 16, 2023, Jane 721 may be displayed above Jack 722.

In some cases, the first user terminal 20 may display the profile 723 of the user who provided a gift, with highest priority. For example, when Mike 723 provided a gift to the first user through a gifting interface on Sep. 13, 2023, Mike may be displayed above Jane even if Jane 721 sent a reaction on Sep. 17, 2023. In this case, the first user terminal 20 may display the information 730 related to the gift (specific feature). For example, the first user terminal 20 may display a gift icon 730 next to the profile information of Mike 723.

The first user terminal 20 may check gifts received from other user terminals through the gift box viewing interface (detailed information viewing interface related to a specific feature) 740.

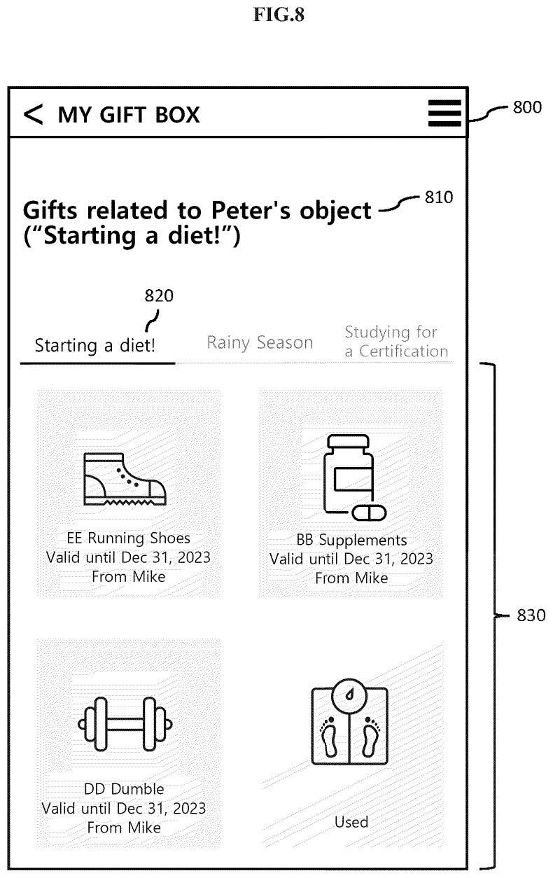

FIG. 8 illustrates the first user terminal 20 displaying a gift box 800 related to an object.

FIG. 8 may be displayed in response to an interaction with the gift box viewing interface 740 in FIG. 7.

Referring to FIG. 8, the gift box 800 may include information 810 related to an object, a tab area 820 related to the object, and information 830 about a received gift.

When the first user terminal 20 has received gifts for a plurality of objects, the first user terminal 20 may display the gifts separately by object. The first user terminal 20 may display objects in various ways.

For example, the first user terminal 20 may distinguish the plurality of objects through a tab area. Specifically, the first user terminal 20 may post an object such as “Start a diet!” and receive a gift related to the object. In this case, the first user terminal 20 may display a tab 820 corresponding to “Starting a diet!” in the tab area. In this case, the first user terminal 20 may display a tab 820 corresponding to “Start a diet!” in the tab area. Additionally, the first user terminal 20 may display gifts related to that object in the tab 820 corresponding to “Starting a diet!”

A tab corresponding to each object may be deleted if all the received gifts are used or if the usage period expires. For example, if all the gifts included in the tab corresponding to “Starting a diet!” have been used or if the usage period for all gifts (e.g., Dec. 31, 2023) has expired, the “Starting a diet!” tab may be deleted from the tab area 820.

The first user terminal 20 may display the information 830 about each gift. Specifically, the information 830 about the gift may include a product's name, the product's usage period, and information about a gift sender.

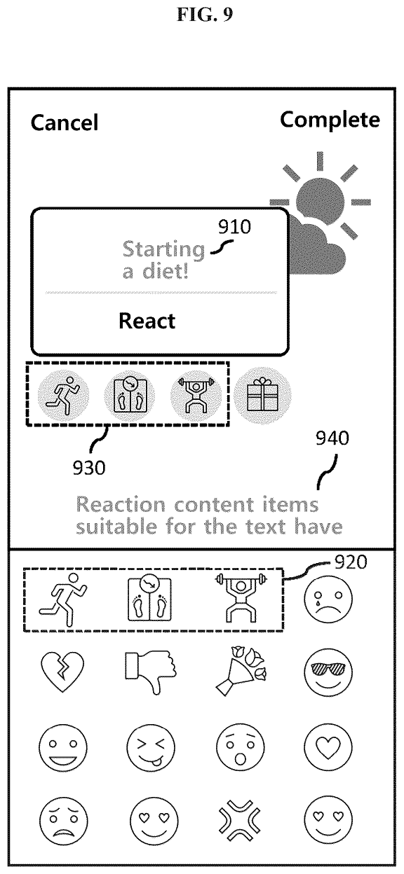

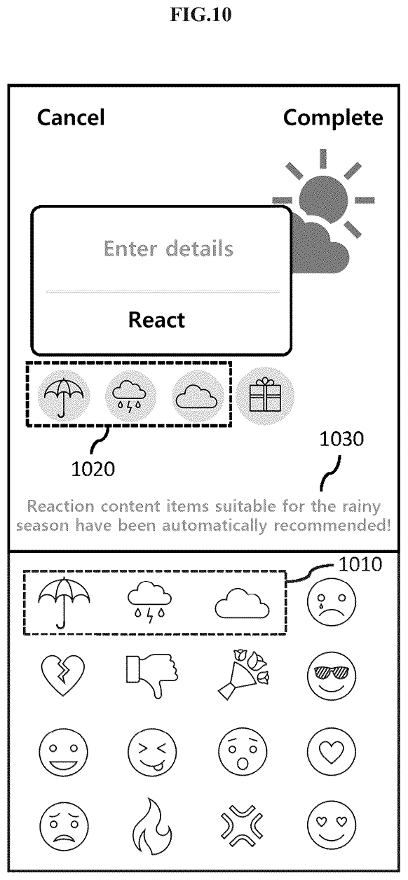

FIGS. 9 and 10 illustrate various embodiments of a method for providing a candidate reaction content to the first user terminal 20 by the server 10 to perform operation 201 of FIG. 2.

FIG. 9 illustrates a screen where the first user terminal 20 displays candidate reaction contents 920 related to a description included in an object, according to an embodiment of the present disclosure.

Referring to FIG. 10, the object may include a details area and a reaction area. The first user terminal 20 may input specific details 910 into the details area. In this case, the server 10 may provide a reaction content 920 related to the specific details 910 to the first user terminal 20. In some cases, the first user terminal 20 may display the reaction content 920 related to the specific details 910 in priority over the candidate reaction contents.

For example, the server 10 may receive details such as “Starting a diet!” 910 from the first user terminal 20. In this case, the server 10 may display a reaction content related to “diet” (e.g., “running, weight scale, and weight training emoticons” 920) at the top of the candidate reaction contents on the first user terminal 20. In some cases, the first user terminal 20 may display such a reaction content (e.g., “running, scale, and strength training emojis” 920) on the reaction interface 930.

Although not shown in the drawings, the first user terminal 20 may transmit a request to the server 10 to select at least one other reaction content as a custom reaction content, rather than the reaction content 920 related to the specific details.

The first user terminal 20 may display information 940 indicating that reaction contents corresponding to a text have been recommended on the first user's profile screen. For example, the first user terminal 20 may display guide information around the candidate reaction contents, such as “Reaction contents suitable for the text have been recommended.” 940.

FIG. 10 illustrates a screen where the first user terminal 20 displays a reaction content 1010 related to a posting time of an object, according to an embodiment of the present disclosure.

Referring to FIG. 10, the server 10 may provide candidate reaction contents for a custom content to the first user terminal 20. When a characteristic of an object meets a predetermined condition, the server 10 may display the reaction content 1010 related to the characteristic of the object in the candidate reaction contents.

For example, the characteristic of the object may correspond to a posting time of the object. Specifically, the first user terminal 20 may transmit a request to the server 10 to create an object including the reaction content 1010. When the posting time of the object meets a predetermined condition, the server 10 may provide the reaction content 1010 related to a specific time to the first user terminal 20.

For example, if the posting time of the object corresponds to the “Rainy Season,” the server 10 may provide the reaction content 1010, such as umbrella, rain, and cloud emoticons 1010, related to the “Rainy Season.” In some cases, the first user terminal 20 may display the reaction content 1010 related to the specific time in priority over the candidate reaction contents. In some cases, the first user terminal 20 may display such a reaction content (e.g., the umbrella, rain, and cloud emoticons 1010) on a reaction interface 1020.

In another example, the characteristic of the object may correspond to a type of the object. Specifically, the object may be related to challenges, empathy, celebration, support, praise, etc. In such cases, the server 10 may provide a reaction content related to a specific type to the first user terminal 20.

The first user terminal 20 may display information 1030 indicating that reaction contents corresponding to the characteristic of the object have been recommended on the first user's profile screen. For example, the first user terminal 20 may display guide information around the candidate reaction contents, such as “Reaction contents suitable for the rainy season is automatically recommended!” 1030.

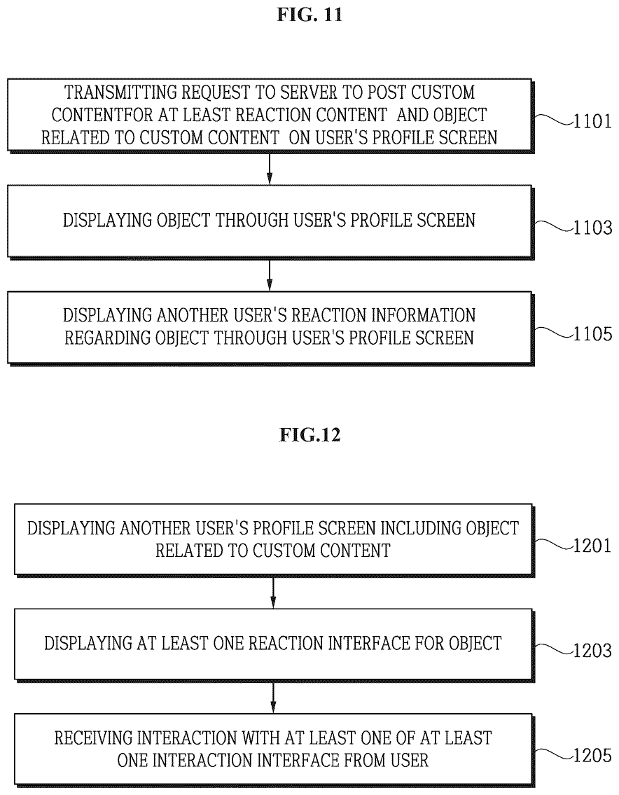

FIG. 11 is a flowchart for explaining a method for displaying reaction information for an object through a profile screen on a first user terminal 20 according to the present disclosure.

For convenience of explanation, the description of the operations in FIG. 11 substantially identical to the operations in FIG. 2 will be replaced by the description referenced in FIG. 2.

In operation 1101, the first user terminal 20 transmits a request to the server 10 to post a custom content for at least one reaction content and an object related to the custom content on the user's profile screen. Since operation 1101 is substantially identical to operation 201 in FIG. 2, the description of operation 1101 will be replaced by the description of operation 201 in FIG. 2.

In operation 1103, the user terminal 30 displays the object through the user's profile screen. Since operation 1103 is substantially identical to operation 203 in FIG. 2, the description of operation 1103 will be replaced by the description of operation 203 in FIG. 2.

In operation 1105, the user terminal 30 displays another user's reaction information for the object through the user's profile screen. Since operation 1105 is substantially identical to operation 209 in FIG. 2, the description of operation 1105 will be replaced by the description of operation 209 in FIG. 2.

FIG. 12 is a flowchart illustrating a method for displaying a custom content(s) and a method for displaying a reaction content selected from among custom contents on a second user terminal 30 according to the present disclosure.

For convenience of explanation, the description of the operations in FIG. 12 that are substantially identical to the operations in FIG. 2 will be replaced by the description referenced in FIG. 2.

In operation 1201, the user terminal 30 displays another user's profile screen including an object related to a custom content. Since operation 1201 is substantially identical to operation 203 in FIG. 2, the description of operation 1201 will be replaced by the description of operation 203 in FIG. 2.

In operation 1203, the user terminal 30 displays at least one reaction interface for the object. Since operation 1203 is substantially identical to operation 205 in FIG. 2, the description of operation 1203 will be replaced by the description of operation 205 in FIG. 2.

In operation 1205, the user terminal 30 receives an interaction with at least one of the reaction interfaces from the user. Since operation 1205 is substantially identical to operation 207 in FIG. 2, the description of operation 1205 will be replaced by the description of operation 207 in FIG. 2.

According to the present disclosure, it is possible to post an object through an object creator's profile screen and provide a reaction interface to the object to a user who accesses the object creator's profile screen.

According to the present disclosure, it is possible to provide a reaction interface and a gifting interface together with respect to the object, enabling a user who viewed the object to offer a gift along with the user's reaction to the object's poster.

The technical features disclosed in each embodiment of the present disclosure are not limited to a corresponding embodiment, and unless incompatible with each other, the technical features disclosed in each embodiment may be applied in combination to other embodiments.

Therefore, although each embodiment is described mainly about an individual technical feature, the technical features of the embodiments of the present disclosure may be applied in combination, unless incompatible with each other.

The present disclosure is not limited to the above-described embodiments and the accompanying drawings, and various modifications and changes may be made in view of a person skilled in the art to which the present disclosure pertains. Therefore, the scope of the present disclosure should be determined by the scope of the appended claims, and equivalents thereof.

What is claimed is:

1. A method for providing reaction contents by a server, the method comprising:
receiving a request to post a custom content for at least one reaction content and an object related to the custom content on a first user's profile screen from a first user terminal;
in response to a request to view a first user's profile screen from a second user terminal, providing the first user's profile screen comprising the object to the second user terminal;
providing information about the custom content to be displayed as part of at least one reaction interface for the object to the second user terminal;
receiving an interaction with at least one of the at least one reaction interface from the second user terminal; and
providing reaction information associated with the interaction to the first user terminal.

2. The method of claim 1, wherein the at least one reaction interface comprises a custom interface based on the custom content and a default interface unrelated to the custom content.

3. The method of claim 1, wherein the at least one reaction interface comprises a reaction content interface related to a reaction content and a feature interface connected to a specific feature.

4. The method of claim 3, wherein the specific feature comprises at least one of the following: a feature of providing a gift to the first user or a feature of sending a message to the first user.

5. The method of claim 3, further comprising:
in response to receiving an interaction with the feature interface from the second user terminal, providing a feature window for performing the specific feature to the second user terminal,
wherein the feature window comprises information related to the object.

6. The method of claim 5, wherein the information related to the object comprises at least one of the following: information about details received in relation to the object from the first user terminal or characteristic information related to the first user.

7. The method of claim 3, further comprising:
in response to receiving an interaction with the feature interface from the second user terminal, providing a feature window for performing the specific feature to the second user terminal,
wherein the feature window is displayed overlapping at least a part of the first user's profile screen.

8. The method of claim 3, wherein the reaction information comprises at least one of the following: information about a reaction content associated with the interaction, information about a specific feature associated with the interaction, or profile information about the second user.

9. The method of claim 3, wherein:
the specific feature is a feature of providing a gift to the first user, and
the reaction information comprises a viewing interface that allows viewing information about a gift provided by the first user in relation to the object.

10. The method of claim 3, wherein:
the specific feature is a feature of providing a gift to the first user, and
the method further comprises, in response to the object being provided in plural, providing information on at least one of gifts received by the first user to the first user terminal, separately by object.

11. The method of claim 1, wherein the reaction interface is displayed overlapping at least a part of the first user's profile screen.

12. The method of claim 1, wherein providing the reaction interface is performed in response to an interaction from the second user terminal with the object.

13. The method of claim 1, wherein:
the object comprises a details area, comprising details received from the first user terminal in relation to the object, and a reaction area related to a reaction to the object, and
at least one of the at least one reaction interface is provided within the reaction area.

14. The method of claim 1, wherein:
receiving the request comprises receiving information designating one of the at least one reaction content as a designated reaction content from the first user terminal, and
the object is displayed comprising the designated reaction content.

15. The method of claim 1, wherein:
receiving the request comprises providing candidate reaction contents selectable as the custom content to the first user terminal, and
the candidate reaction contents are related to the first user's history information regarding the at least one reaction content.

16. The method of claim 15, wherein:
the at least one reaction content comprises an emoticon, and
the history information is associated with at least one of the following: the first user's recent usage history, favorite designation history, purchase history, download history, and retention history regarding emoticons.

17. The method of claim 1, wherein:
receiving the request comprises providing candidate reaction contents selectable as the custom content to the first user terminal,
the candidate reaction contents comprise a reaction content related to a characteristic of the object.

18. The method of claim 17, wherein the characteristic of the object comprises at least one of the following: a posting time of the object or details received from the first user terminal in relation to the object.

19. A server providing reaction contents, the server comprising:
a memory storing instructions, and
a processor configured to execute the instructions to:
receive a request to post a custom content for at least one reaction content and an object related to the custom content on a first user's profile screen from a first user terminal;
in response to a request to view the first user's profile screen from a second user terminal, provide the first user's profile screen comprising the object to the second user terminal;
providing information about the custom content to be displayed as part of at least one reaction interface for the object to the second user terminal;
receive an interaction with at least one of the at least one reaction interface from the second user terminal; and
provide reaction information associated with the interaction to the first user terminal.

20. A method for displaying a reaction interface by a user terminal, the method comprising:
displaying another user's profile screen comprising an object related to a custom content, wherein the custom content is obtained based on the another user's selection of at least one reaction content;
displaying at least one reaction interface for the object, wherein at least one of the at least one reaction interface is based on the custom content; and
receiving an interaction with at least one of the at least one reaction interface from the another user.
